(19) United States
(12) Patent Application Publication
(10) Pub. No.: US 2018/0309277 A1
(43) Pub. Date: Oct. 25, 2018

(54) COVER FOR AN OPENING/RECESS IN A WALL OR CEILING

(71) Applicants: Dietmar Haubenhofer, Ilvesheim (DE); Thorsten Marcus Gehrmann, Heddesheim (DE)

(72) Inventors: Dietmar Haubenhofer, Ilvesheim (DE); Thorsten Marcus Gehrmann, Heddesheim (DE)

(21) Appl. No.: 15/768,783

(22) PCT Filed: Oct. 16, 2015
(86) PCT No.: PCT/DE2015/200479

§ 371 Date: Apr. 16, 2018

(51) Int. Cl. H02G 3/08; H02G 3/14

(52) U.S. Cl. CPC H02G 3/081; H02G 3/12; H02G 3/14

(57) ABSTRACT

A covering for an opening/recess in a wall or ceiling, in particular to close flush-mounted sockets, junction boxes, switch boxes, flush-mounted boxes (1) etc., with retention means that can be associated with the opening and with a cover plate (3) held due to the action of magnetic force.

### BACKGROUND

### Technical Field

The disclosure relates to a covering for an opening or recess in a wall or ceiling, in particular to close flush-mounted sockets, junction boxes, switch boxes, flush-mounted boxes, etc. Associated with the opening are retention means that hold what is to be understood in the broadest sense as a cover plate.

Although this very generally involves any openings, cutouts, sockets, boxes, etc. to be closed, the disclosure can be best explained with an example of a classical flush-mounted socket. However, the following explanation does not limit the disclosure to the application for flush-mounted sockets.

### Description of the Related Art

Flush-mounted sockets or switch boxes exist in different designs. They are normally plastered into a classical masonry wall or attached in a hollow wall, with or without sealing insert. Such boxes normally serve to accommodate electrical wiring and connections.

In practice, it is known to close corresponding boxes with covers, wherein the covers are either screwed to the box by means of screws or clipped on by means of mechanical clips. The screws are visible, and the clips do not ensure a secure retention. The danger exists that the cover will fall off.

In the event of maintenance work, a wallpaper glued over the cover must be destroyed, and paintwork has to be cracked. The use of classical coverings is thus disadvantageous from both technical standpoints and aesthetic points of view.

### BRIEF SUMMARY

The disclosure provides a covering of the aforementioned type with which a reversible closing of flush-mounted sockets, etc. is possible without auxiliary technical means. The covering should be of simple construction and at least largely eliminate the disadvantages cited in the prior art.

As described herein, a cover plate is held due to the action of magnetic force, wherein the magnetic force acts between retention means and the cover plate. In principle, it does not matter whether the magnetic field is generated by the retention means or by the cover plate. What is important is that an action of magnetic force is deployed between the retention means and the cover plate, regardless of whether the retention means or the cover plate is magnetic and the respective other component is correspondingly ferromagnetic or ferrimagnetic. In principle, magnetic materials on both sides may also be considered, specifically with opposite polarity.

The retention means are advantageously implemented at points or zonally as part of a frame, or preferably as a frame surrounding the opening. This frame may be introduced into the wall, flush around the opening or recess, e.g., box, socket, etc. It is conceivable that the cover plate as a whole is placed on the frame, or is inserted into a recess of the frame that corresponds to the thickness of the cover plate. The latter variant has the advantage that, in the case of a completely inserted cover plate, a flush termination with the plaster or the wall can be realized, assuming a completely plastered-in frame.

The frame itself may be attached in different ways. It may be plastered around or in the opening of the box. It is also conceivable to screw the frame on or in using the threads normally provided in the box. The frame may likewise be glued, plugged, pressed or clipped on or in. It is to be ensured that a solid connection is guaranteed between the frame and the box or the plaster around the box.

As has already been stated above, it is conceivable that the frame can be screwed or connected to existing screw holes or attachment means of the flush-mounted socket. A secure retention to the box is thereby ensured. Moreover, it is also possible here that, after insertion of the box and attachment of the frame, a flush loading and plastering is realized.

In an additional advantageous manner, the frame has a contact surface, preferably a peripheral contact surface, that is formed in at least one plane. The cover plate comes to rest on this contact surface, whereby a secure retention of the cover plate is ensured under the action of the magnetic force. Before application of the cover plate, it is to be ensured that the surface of the frame, meaning the contact surface, is free of contamination.

The cover plate may have any desired geometric configuration. It is normally round or rectangular, in particular square. It may have an at least slightly larger surface than the area spanned by the frame, especially when the cover plate covers the entire frame. If the cover plate should be inserted into the frame, into a recessed receptacle there, the surface of the cover plate is to be adapted to the receptacle of the frame.

In particular, in the case of electrical applications in wet rooms or basement rooms, it may be necessary that the box be equipped with a safety lock that may be associated with the frame in light of the disclosure. It is thus conceivable that the frame is equipped with a receptacle for preferably flush insertion or for attachment of a safety lock arranged beneath the cover plate. The inserted safety lock may terminate flush with the frame so that the cover plate can be placed atop the peripheral frame, and therefore also atop the safety lock, and can be attached accordingly. The safety lock, like the frame, may be made of ferro-/ferrimagnetic material, for example sheet metal.

It is also conceivable that the frame is connected permanently or releasably to a flush-mounted socket or a flush-mounted box. The frame may even be an integral component of the flush-mounted socket, wherein it is advantageous if at least the frame is produced from ferromagnetic or ferrimagnetic sheet steel. A combination of frame and box via injection molding technology is conceivable.

As was already described above, the frame may be made of a ferromagnetic or ferrimagnetic material. The cover plate may be furnished at least in part with a magnetic material in the sense of a permanent magnet. It is also conceivable that the frame as a whole is made of a magnetic material in the sense of a permanent magnet. The cover plate is especially advantageously designed as a magnetic film, or the cover plate is coated or laminated, at least partially, with a magnetic film on the side facing toward the frame. At this point, it is noted that the association of magnetic material and ferromagnetic or ferrimagnetic material may also be reversed.

In a further advantageous manner, the cover plate is imprinted two-dimensionally or three-dimensionally on the side facing away from the frame, wherein a digital printing method by means of an inkjet printer is suitable. Refer in this regard to the German disclosure document DE 10 2008 034 839 A1, the technique of which is applicable here.

### BRIEF DESCRIPTION OF THE SEVERAL VIEWS OF THE DRAWINGS

There are various options for advantageously designing and developing the teaching of the present disclosure. In this regard, reference is made on the one hand to the claims dependent upon claim 1, and on the other hand to the following explanation of a preferred exemplary embodiment of the disclosure with reference to the drawings. Generally preferred embodiments and developments of the teaching are also explained in conjunction with the explanation of the preferred exemplary embodiment of the disclosure with reference to the drawings. Shown in the drawings are:

FIG. 1 which shows, in a partial schematic view, the frame of a covering according to the disclosure, said covering being made of ferro-/ferrimagnetic material, for placement of a magnetic cover plate, and

FIG. 2 which shows the item from FIG. 1 in a schematic plan view.

### DETAILED DESCRIPTION

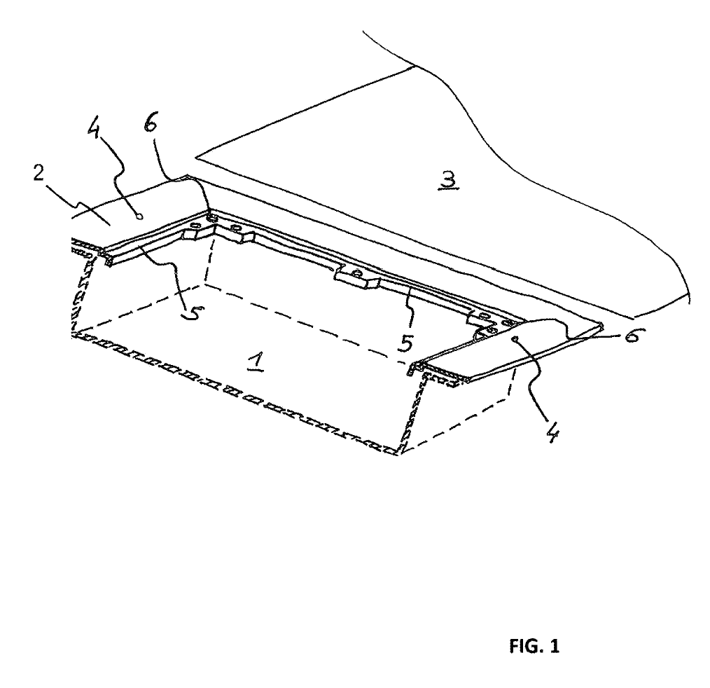

FIG. 1 shows an exemplary embodiment of a covering according to the disclosure, namely for closing a flush-mounted box 1 (which is merely indicated in FIG. 1). For example, the in-wall box 1 may be a switch box or junction box, or other opening, recess, socket, etc.

The covering comprises a peripheral frame 2 that is made of ferromagnetic material, for example ferromagnetic sheet metal. The frame can be permanently connected to the flush-mounted box 1, for example be screwed to it or be plastered into it. The frame 2 is normally plastered in at the region around the flush-mounted box 1.

The covering also includes a cover plate 3 (only partially shown) that is made of a magnetic material. Specifically, this is a magnetic film that comes to rest with its surface on the surface 4 of the frame 2. The surface of the cover plate 3 should be at least as large as the area spanned by the frame 2. The surface of the frame 2 is preferably somewhat larger, namely projects beyond the edge regions of the frame 2.

FIG. 1 further shows that the frame 2 has an inner receptacle 5 in the form of a recess into which a safety lock can be inserted in the form of an inner plate. This inner plate can be inserted into the receptacle 5 of the frame 2 and be attached there, in particular screwed on. For this purpose, the receptacle 5 of the frame 2 is provided with screw holes 6, specifically in order to protect the safety lock against being opened unintentionally.

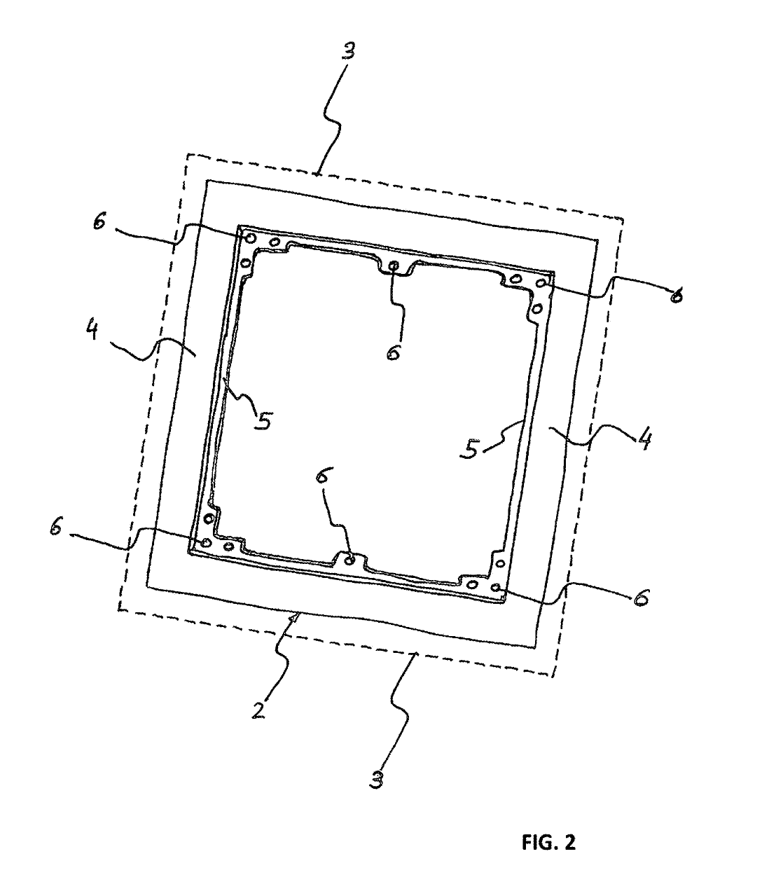

FIG. 2 shows the subject matter of FIG. 1 in a plan view, and accordingly shows the same features as in FIG. 1. The peripheral frame 2 with its surface 4 serving for placement is apparent. The cover plate 3 that comes to rest thereupon under magnetic interaction is indicated by a dashed line.

The inner receptacle 5 with the screw holes 6 provided there is likewise apparent, namely in order to insert the safety lock (which does not necessarily need to be provided) and secure it.

It is further noted that the teaching according to the disclosure is based on the magnetic interaction between the frame 2 and the cover plate 3, regardless of whether the cover plate 3 or the frame 2 are produced from magnetic material. From an inventive standpoint, it depends on the magnetic interaction.

Furthermore, it is noted that the outwardly facing surface of the cover plate 3 may ideally be imprinted, and in fact both two-dimensionally and three-dimensionally, the latter to generate a texture similar to a surface plaster. Partial motifs of a wallpaper, of a mural etc. can also be applied via a printing technique onto the cover plate, specifically in order to match the covering to the environment or surrounding area, so that the discontinuity caused by the cover plate is not or is at best barely perceptible.

With regard to additional advantageous embodiments of the teaching according to the disclosure, reference is made to the general part of the description and also to the accompanying claims to avoid repetition.

Finally, it is expressly noted that the exemplary embodiment of the teaching according to the disclosure as previously described serves only to explain the claimed teaching, but does not restrict it to the exemplary embodiment.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### LIST OF REFERENCE SYMBOLS

1 flush-mounted box
2 frame
3 cover plate
4 area of the frame
5 receptacle of the frame
6 screw holes (in the receptacle of the frame)

1. A covering for an opening or recess in a wall or ceiling with retention means that can be associated with the opening or recess and with a cover plate held due to the action of magnetic force.

2. The covering according to claim 1, wherein the retention means are designed as part(s) of a frame, or as a frame surrounding the opening.

3. The covering according to claim 2, wherein the frame is plastered, screwed, glued, inserted, pressed, or clipped onto or into the opening or recess.

4. The covering according to claim 2, wherein the frame can be screwed or connected to existing screw holes or attachment means of a flush-mounted socket.

5. The covering according to claim 2, wherein the frame has a contact surface formed in one plane onto which the cover plate comes to rest.

6. The covering according to claim 2, wherein the cover plate is designed to be round or rectangular with an area that is at least slightly larger than an area spanned by the frame.

7. The covering according to claim 2, wherein the frame is furnished with a receptacle for flush insertion or attachment of a safety lock arranged beneath the cover plate.

8. The covering according to claim 2, wherein the frame is connected permanently or releasably with a flush-mounted socket or a flush-mounted box.

9. The covering according to claim 2, wherein the frame is made of a ferromagnetic or ferrimagnetic material.

10. The covering according to claim 2, wherein the cover plate comprises at least in part a magnetic material in the sense of a permanent magnet.

11. The covering according to claim 10, wherein the cover plate is designed as a magnetic film.

12. The covering according to claim 1, wherein the cover plate is imprinted two-dimensionally or three-dimensionally on the side facing away from the frame.

13. The covering according to claim 1, wherein the cover is to close a flush-mounted socket, a junction box, a switch box, or a flush-mounted box.

14. The covering according to claim 6, wherein the cover plate is designed to be square.

15. The covering according to claim 2, wherein the frame is an integral component of a flush-mounted box.

16. The covering according to claim 2, wherein the cover plate is made of a magnetic material in the sense of a permanent magnet.

17. The covering according to claim 10, wherein the cover plate is coated or laminated at least in part with a magnetic film on the side facing toward the frame.

18. The covering according to claim 1, wherein the cover plate is imprinted two-dimensionally or three-dimensionally by way of digital printing.
